(19) United States
(12) Patent Application Publication
(10) Pub. No.: US 2004/0069829 A1
(43) Pub. Date: Apr. 15, 2004

(54) Postprocessing apparatus and postprocessing method

(75) Inventors: Ryoji Watanabe, Kanagawa (JP); Akihiko Takada, Kanagawa (JP); Masayoshi Sakakibara, Kanagawa (JP); Hajime Kishimoto, Kanagawa (JP); Yasuo Horino, Tokyo (JP); Toshiyuki Yano, Kanagawa (JP); Yasuhiro Matsuo, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/647,292

(22) Filed: Aug. 26, 2003

(30) Foreign Application Priority Data
Aug. 28, 2002 (JP) 2002-248786
Jun. 13, 2003 (JP) 2003-169620

(51) Int. Cl. B31B 1/00

(52) U.S. Cl. 227/19

(57) ABSTRACT

A printing unit of a copying apparatus forms an image on a printing paper by way of an electrophotographing system in response to an operation executed with respect to a UI apparatus. A postprocessing unit of the copying apparatus staples a staple needle holding an IC chip to the printing paper on which the image is formed. Then, the postprocessing unit writes data input from the UI apparatus into the IC chip held by the staple needle.

The present disclosure relates to the subject matter contained in Japanese Patent Application No. 2002-248786 filed on Aug. 28, 2002 and Japanese Patent Application No. 2003-169620 filed on Jun. 13, 2003, which are incorporated herein by reference in its entirety.

### BACKGROUND OF THE INVENTION

1. Field of the Invention

The present invention relates to a postprocessing apparatus and a postprocessing method, which mounts a non-contact memory on an image forming member on which an image is formed.

2. Description of the Related Art

A compact semiconductor chip (for example, u-chip by HITACHI, LTD.) from which an external unit can read stored data in a non-contact manner has been known.

Also, JP-A-2001-229199, JP-A-2000-285203, JP-A-2001-134672, JP-A-2001-283011, JP-A-2001-148000, and JP-A-2001-260580 disclose applications of the compact semiconductor chip.

A very small-sized semiconductor chip is attached to a paper medium, and information is stored in this semiconductor chip. Thereby, the information stored in this semiconductor chip can be supplied in addition to image information printed on the surface of the paper medium.

As a method of printing an image on a paper medium, when an electrophotographic system is employed, a transfer process for transferring a toner image onto the paper medium and a fixing process for fixing the transferred image on the paper medium are carried out. Under these transferring/fixing processes, the paper medium is exposed to either a high temperature environment or a high voltage environment.

Heat, or high voltages adversely influence the semiconductor chip attached to a paper medium. Therefore, there is feared that this semiconductor chip may be destroyed under either high temperature or high voltage environments in the image forming process.

### SUMMARY OF THE INVENTION

The invention has been made based on the technical background. An object of the invention is to provide a postprocessing apparatus and a postprocessing method, which can mount a semiconductor chip on an image forming member on which an image is (alternatively, has been) formed, and prevents the semiconductor chip (storage medium) from being destroyed high temperatures or high voltages, which occur during the image forming process.

[Postprocessing Apparatus]

To achieve the above described object, according to a first aspect of the invention, a postprocessing apparatus performs a postprocessing with respect to an image forming member on which an image is to be formed. The postprocessing apparatus includes an attachment unit for attaching a storage medium to the image forming member on which it has started to form the image.

Preferably, the attachment unit attaches the storage medium to the image forming member after a process of transferring the image onto the image forming medium.

Preferably, the attachment unit attaches the storage medium to the image forming member after a process of fixing the image onto the image forming member.

Preferably, the postprocessing apparatus further includes a data writing unit for writing data into the storage medium.

Preferably, the data writing unit writes data input by user into the storage medium.

Preferably, the data writing unit writes the data into the storage medium attached to the image forming member.

Preferably, the attachment unit attaches the storage medium based on an operation of user.

Preferably, the postprocessing apparatus further includes a communication interface connected to an external terminal through a network and receiving an operation of instructing the attachment of the storage medium from the external terminal. The attachment unit attaches the data storage unit in response to the received operation.

Preferably, a staple needle holds the storage medium. The attachment unit staples the staple needle holding the storage medium to the image forming member to attach the storage medium to the image forming member.

Preferably, the attachment unit staples the staple needle to the single image forming member.

Preferably, an adhesive member holds the storage medium. The attachment unit attaches the adhesive member holding the storage medium to the image forming member.

[Staple Needle]

According to a second aspect of the invention, a staple needle is to be attached to a sheet-shape member. The staple needle includes a holding portion for holding a storage medium, which stores data.

Also, according to a third aspect of the invention, a staple needle is to be attached to a sheet-shape member. The staple needle includes a data storage unit for storing data.

Preferably, at least a part of the staple needle serves as an antenna for transmitting/receiving the stored data.

[Postprocessing Method]

According to a fourth aspect of the invention, a method performs a postprocessing with respect to an image forming member on which an image is to be formed. The method includes attaching a storage medium to the image forming member on which it has started to form the image.

### BRIEF DESCRIPTION OF THE DRAWINGS

FIG. 1A is a diagram for exemplifying a first staple needle employed in a postprocessing method of the present invention, and FIG. 1B is a diagram for exemplifying the first staple needle which has been stapled.

FIG. 2 is a diagram for exemplifying a printing paper to which the staple needle (FIG. 1) has been attached.

FIG. 3 is a diagram for representing a hardware structure of a copying apparatus to which a postprocessing method according to the present invention is applied, i.e., for mainly exemplifying a control apparatus thereof.

FIG. 4 is a diagram for exemplifying a hardware structure of the copying apparatus shown in FIG. 3, i.e., for mainly exemplifying both a printing unit thereof and the postprocessing unit.

FIG. 5 is a diagram for showing a structure of an IC chip indicated in FIG. 1A.

FIG. 6 is a diagram for indicating a structure of an IC chip IF shown in FIG. 3 and FIG. 4.

FIG. 7 is a diagram for representing a structure of a printing program which is executed by the control apparatus (FIG. 3 and FIG. 4) so as to realize the post processing method according to the present invention.

FIG. 8 is a flow chart for describing operations (S10) of the copying apparatus (printing program).

FIG. 9A shows an outer appearance in the case that a second staple needle 42b is viewed from an oblique direction, and FIG. 9B is a diagram for explaining a sectional view of the second staple needle 42b indicated in FIG. 9A, taken along a two-dot/dash line thereof. FIG. 9B includes an enlarged view of the IC chip 3 surrounded by dotted lines.

FIG. 10A shows an outer appearance in the case that a third staple needle 42c is viewed from an oblique direction, and FIG. 10B is a diagram for explaining a sectional view of the third staple needle 42c indicated in FIG. 10A, taken along a two-dot/dash line thereof.

FIG. 10B includes an enlarged view of the IC chip 3 surrounded by dotted lines.

FIG. 11A indicates an outer appearance in the case that a fourth staple needle 42d is viewed from an oblique direction, and FIG. 11B is a diagram for explaining a sectional view of the fourth staple needle 42d indicated in FIG. 11A, taken along a two-dot/dash line thereof.

FIG. 11B includes an enlarged view of the IC chip 3 surrounded by dotted lines.

FIG. 12A indicates an outer appearance in the case that a fifth staple needle 42e is viewed from an arrow-X direction, and FIG. 12B is a diagram for explaining a sectional view of the fifth staple needle 42e indicated in FIG. 12A, taken along a two-dot/dash line thereof.

FIG. 12B includes an enlarged view of the IC chip 3 surrounded by dotted lines.

FIG. 13A represents an outer appearance in the case that a sixth staple needle 42f is viewed from an arrow-X direction, and FIG. 13B is a diagram for explaining a sectional view of the sixth staple needle 42f indicated in FIG. 13A, taken along a two-dot/dash line thereof.

FIG. 13C represents is another sectional view of the sixth staple needle 42f after stapled (a printing paper is not shown).

FIG. 14A represents an outer appearance in the case that a seventh staple needle 42g is viewed from an arrow-X direction, and FIG. 14B is a diagram for explaining a sectional view of the seventh staple needle 42g indicated in FIG. 14A, taken along a two-dot/dash line thereof.

FIG. 15 is a diagram for showing an adhesive tape, which holds thereon an IC chip in an exemplification manner.

FIG. 16 is a diagram for representing a structural arrangement of a second copying apparatus for mounting an IC chip 3 by utilizing the adhesive tage (FIG. 15) in an exemplification manner.

FIG. 17 is a flow chart for explaining operations (S12) of the second copying apparatus (printing program) using the adhesive tape.

FIG. 18 is a diagram for showing a network structure of the copying apparatus which is commonly used by a plurality of computer terminals.

### DETAILED DESCRIPTION OF THE PREFERRED EMBODIMENT

In a postprocessing method according to an embodiment of the invention, for example, a staple needle, which holds thereon a semiconductor chip, is stapled with respect to a paper medium on which an image has been formed to mount the semiconductor chip thereon.

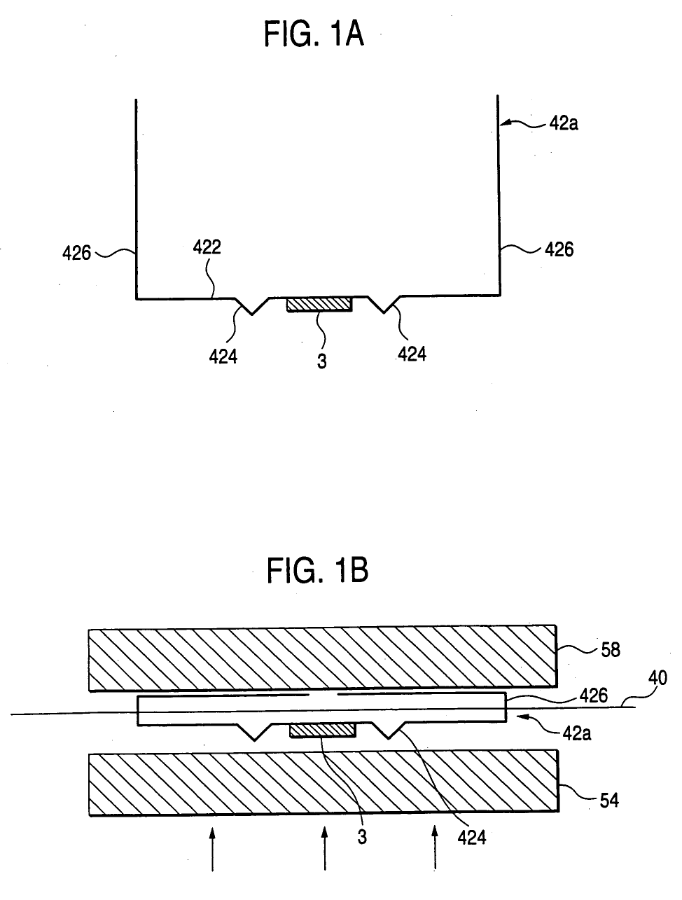

FIG. 1A shows an example of a first staple needle 42a, which is used in the postprocessing method of the invention. FIG. 1B shows an example of the staple needle 42a, which has been stapled.

As shown in FIG. 1A, the staple needle 42a is made of a “U-shaped” metal piece. This metal staple needle 42a includes a holding portion 422 (storage-medium holding portion) for holding thereon an IC chip 3, projection portions 424 which are projected from the holding portion 422, and needle-shaped leg portions 426, which project from both edges of the holding portion 422 at a substantially right angle.

When the holding portion 422 is stapled in a printing paper 40, a U-shaped inner plane of the staple needle 42a is engaged with the printing paper 40. The IC chip 3 is held on a rear plane of a plane, which is engaged with the printing paper 40.

The projection portions 424 of this staple needle 42a are provided on the same plane where the IC chip 3 of the holding portion 422 is held.

The projection portions 424 are arranged in the vicinity of the both edges of the IC chip 3, and project from the IC chip 3 at a level higher than this IC chip 3.

Assuming that the holding portion 422 is set as a reference. The leg portions 426 project along a direction opposite to the IC chip 3 and the projection portions 424.

As shown in FIG. 1B, when the stapler 42a is depressed by a stapler 54, after the leg portions 426 passes through the printing paper 40, these leg portions 426 abut against a needle receiving base 58 and then are bent.

Since the projection portion 424 project at the higher level from the IC chip 3, when the staple needle 42a is depressed, the projection portions 424 prevent the IC chip 3 from being depressed by the stapler 54.

A portion of the staple needle 42a may function as an antenna when the IC chip 3 transmits/receives data.

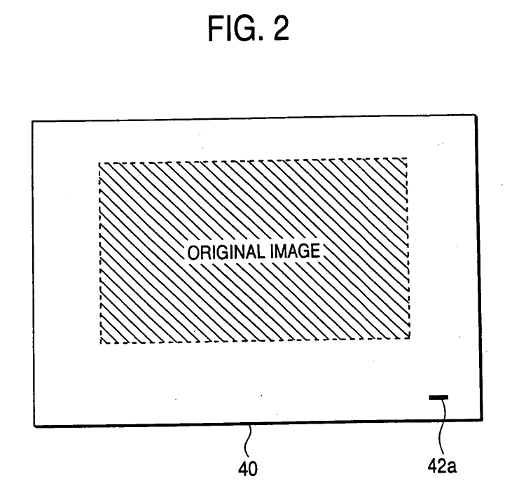

FIG. 2 is a diagram for showing an example of the printing paper 40 to which the staple needle 42a (FIG. 1) is attached.

As shown in FIG. 2, the staple needle 42a is attached to the printing paper 40 (image forming member) on which an original image is printed.

The IC chip 3 (FIG. 2) is held on the staple needle 42a. This printing paper 40 can provide information stored in the IC chip 3 in addition to the original image printed thereon.

As described above, the postprocessing method according to the embodiment of the invention staples the staple needle 42a on the printing paper 40 after the image is printed thereon. Thereby, the IC chip 3 is added to the printing paper 40.

[Embodiment]

An embodiment of a postprocessing method according to the present invention will now be described more in detail with reference to a specific example.

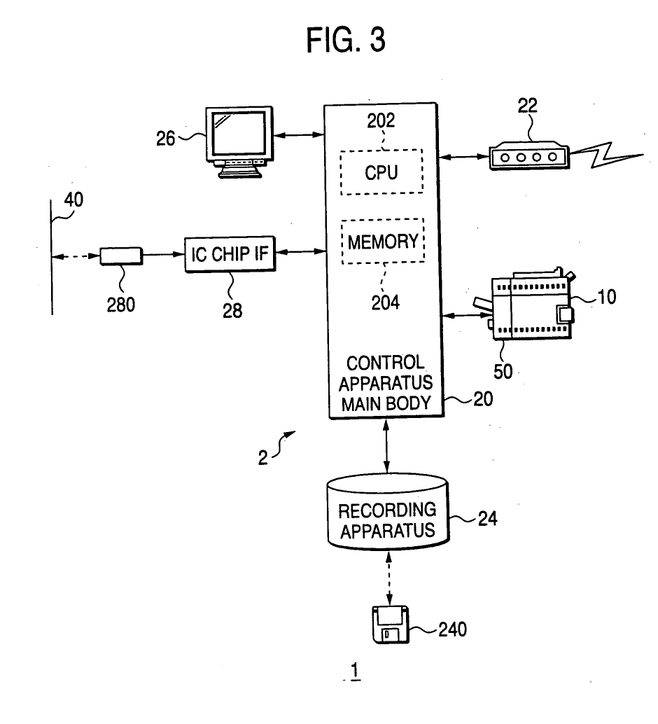

FIG. 3 is a diagram for showing a hardware structure of a copying apparatus 1 to which a postprocessing method according to the embodiment of the invention is applied. FIG. 3 mainly shows a control apparatus 2.

As shown in FIG. 3, the copying apparatus 1 includes the control apparatus 2 for controlling an entire unit of the copying apparatus 1, a printing unit 10 for forming an image, and a postprocessing unit 50 for performing a postprocessing such as a staple process.

The printing unit 10 prints an image on the printing paper 40 by using an electrophotographic system.

The postprocessing unit 50 staples the staple needle 42a on, for example, the printing paper 40.

The control apparatus 2 includes a control apparatus main body 20, a communication apparatus 22, a recording apparatus 24 such as an HDD/CD apparatus, a user interface apparatus (UI apparatus) 26, and an IC chip interface (IC chip IF) 28 (data writing means). The control apparatus main body 20 contains a CPU 202, a memory 204, and the like. The user interface apparatus 26 contains either an LCD display apparatus or a CRT display apparatus, and a keyboard/touch panel, and so on. The IC chip interface 28 contains an antenna 280.

[Copying Apparatus 1]

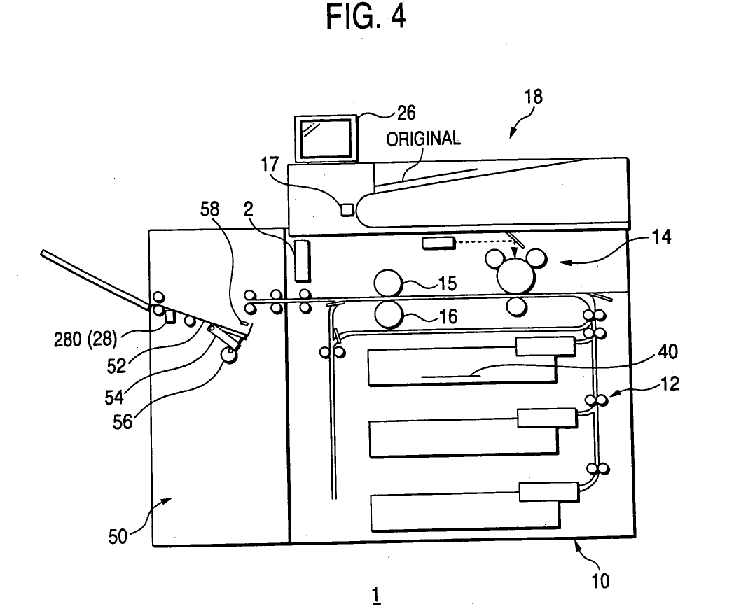

FIG. 4 is a diagram for showing an example of a hardware structure of the copying apparatus 1 indicated in FIG. 3. FIG. 4 mainly shows the printing unit 10 and the postprocessing unit 50 of this copy apparatus 1.

As shown in FIG. 4, the printing unit 10 includes a paper tray part 12, a print engine 14, a fixing roller 15, a pressure roller 16, a scanner 17, an original feeding apparatus 18, and so on. The print engine 14 forms a toner image on the printing paper 40. The fixing roller 15 heats the toner image formed on the printing paper 40 to fix the heated toner image on the printing paper 40. The pressure roller 16 depresses the printing paper 40 along a direction of the fixing roller 15. The scanner 17 reads an image of an original. The original feeding apparatus 18 feeds the original.

The postprocessing unit 50 includes a compile tray 52, a stapler 54 (mounting unit), a cam 56, a needle receiving base 58, and the like. The compile tray 52 stores thereinto the printing paper 40 transported from the printing unit 10. The stapler 54 staples the staple needle 42a (FIG. 1) to the printing paper 40 stored in the compile tray 52. The cam 56 rotates an eccentric shaft (not shown in detail) so as to depress the stapler 54. The needle receiving base 58 receives the staple needle 42a and bends this received staple needle 42a.

Also, the IC chip IF 28 and the antenna 280 are arranged in the vicinity of a transport path through which the printing paper 40 is transported, which is postprocessed in the postprocessing unit 50. The UI apparatus 26 is arranged at an upper portion of the printing unit 10.

In other words, the copying apparatus 1 may be realized by employing a hardware structure that the IC chip IF 28 and the antenna 280 are added to a general-purpose copying apparatus in which an image of an original is read to be printed on the printing paper 40 and then, the image-printed printing paper 40 is postprocessed by way of a staple process.

It should be understood that as shown in FIG. 4, the control apparatus 2 (FIG. 3) is actually stored into the printing unit 10, and the IC chip IF 28 and the antenna 280 (FIG. 3) are stored into the postprocessing unit 50. [IC CHIP 3/IC CHIP IF 28]

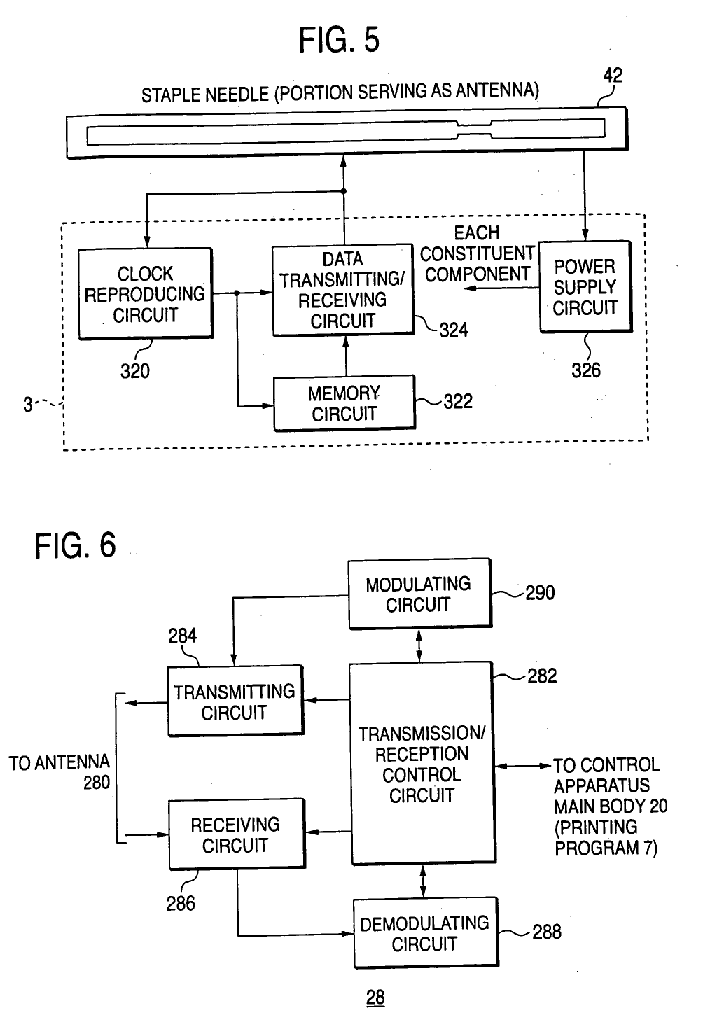

FIG. 5 is a diagram for schematically showing a structure of the IC chip 3 shown in FIG. 1A.

FIG. 6 is a diagram for schematically showing a structure of the IC chip IF 28 shown in FIGS. 3 and 4.

As shown in FIG. 5, the IC chip 3 includes a clock reproducing circuit 320, a memory circuit 322, a data transmitting/receiving circuit 324, and a power supply circuit 326.

Also, as shown in FIG. 6, the IC chip IF 28 includes a transmitting circuit 284, a receiving circuit 286, a transmission/reception control circuit 282, a demodulating circuit 288, and a modulating circuit 290.

In accordance with the below-mentioned operations of each constituent component of the IC chip 3 and the IC chip IF 28, information (data), which is stored in the IC chip 3, is read therefrom via the IC chip IF 28 in a non-contact manner.

In the IC chip 3 (see FIG. 5), the power supply circuit 326 rectifies an electromagnetic wave signal supplied via the staple needle 42a (FIG. 1 and FIG. 5) to supply electric power to each constituent component of the IC chip 3, while this electric power is required for the constituent components.

The clock reproducing circuit 320 reproduces a clock signal from the electromagnetic wave signal supplied from via the staple needle 42a (FIG. 2 and FIG. 5) from the IC chip IF 28 and then, outputs this reproduced clock signal to the memory circuit 322 and the data transmitting/receiving circuit 324.

The memory circuit 324 is, for example, a nonvolatile RAM (random access memory). This memory circuit 324 stores thereinto data indicating information, which is input from the data transmitting/receiving circuit 324 in synchronization with the clock signal input from the clock reproducing circuit 320.

Also, the memory circuit 322 outputs data indicating information stored therein to the data transmitting/receiving circuit 324 in synchronization with the clock signal.

The data transmitting/receiving circuit 324 demodulates the electromagnetic wave signal input via the staple needle 42a (FIGS. 1 and 5) into data and then, outputs this demodulated data to the memory circuit 322 in synchronization with the clock signal input from the clock reproducing circuit 320.

Also, the data transmitting/receiving circuit 324 changes a reflection intensity of an electromagnetic wave signal supplied from the IC chip IF 28 in accordance with a value of data input from the memory circuit 322 in synchronization with the clock signal.

As described above, the data indicating the information, which is stored in the memory circuit 322, is transmitted from the IC chip 3 to the IC chip IF 28 by changing the intentisy of the reflection signal of the electromagnetic wave signal transmitted from the IC chip IF 28 to the IC chip 3.

In the IC chip IF 28 (FIG. 6), the transmission/reception control circuit 282 controls an operation of each constituent component of the IC chip IF 28.

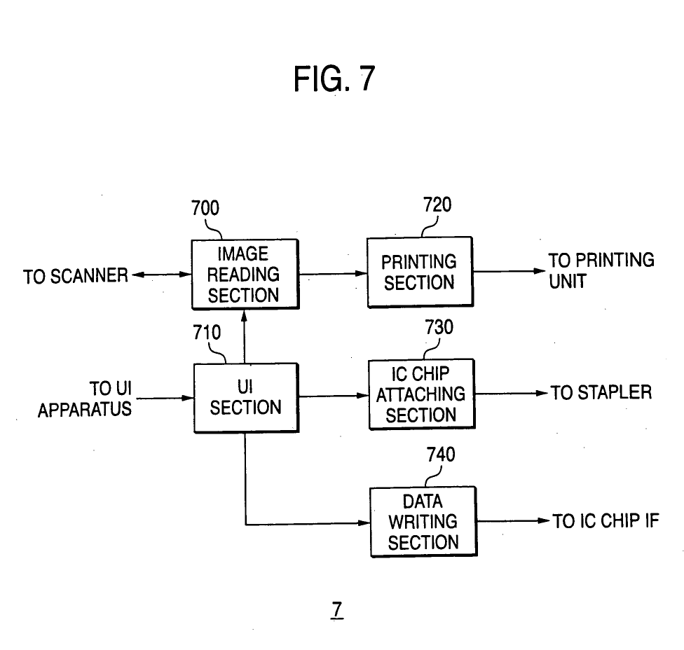

Also, this transmission/reception control circuit 282 outputs data input from the control apparatus main body 20 (printing program 7, which will be discussed later with reference to FIG. 7) to the modulating circuit 290.

Further, this transmission/reception control circuit 282 outputs data, which has been received by the reception circuit 286 and then has been demodulated by the demodulating circuit 288, to the control apparatus main body 20.

The modulating circuit 290 modulates a high frequency signal (radio frequency signal) based on data input from the transmission/reception control circuit 282 to produce an electromagnetic wave signal and then, outputs this produced electromagnetic wave signal to the transmitting circuit 284.

The transmitting circuit 284 transmits the electromagnetic wave signal via the antenna 280 to the IC chip 3. This electromagnetic wave signal contains data to be stored in the IC chip 3, and the clock signal.

The receiving circuit 296 receives a reflection signal, which is reflected from the IC chip 3, and then outputs this received reflection signal to the demodulating circuit 288.

The modulating circuit 288 demodulates the data transmitted from the IC chip 3 based on a change of the reflection signal input from the receiving circuit 286, and then outputs the demodulated data to the transmission/reception control circuit 282.

[Printing Program 7]

FIG. 7 is a block diagram for schematically showing a structure of a printing program 7, which is executed by the control apparatus 2 (see FIGS. 3 and 4) to realize the postprocessing method according to the embodiment of the invention.

As shown in FIG. 7, the printing program 7 includes an image reading section 700, an UI section 710, a printing section 720, an IC chip attaching section 730, and a data writing section 740.

The printing program 7 is supplied via, for instance, the recording medium 240 (FIG. 3) to the control apparatus 2, and then is loaded to the memory 204 so as to be executed.

In the print program 7, the image reading section 700 controls the constituent components of the printing unit 10 such as the scanner 17 (FIG. 4) to read an original image displayed on an original.

The UI section 710 receives an operation of a user with respect to the UI apparatus 26 (FIGS. 3 and 4), and outputs data for instructing mounting of the IC chip 3 to the IC chip attaching section 730.

Also, the UI section 710 receives an operation of the user with respect to the UI apparatus 26, and outputs data, which is to be written into the IC chip 3, to the data writing section 740.

When data of an original image is input from the image reading section 700, the printing section 720 controls each constituent component of the printing unit 10 such as the print engine 14 (FIG. 4) to print the original image on the printing paper 40.

When the IC chip attaching section 730 is instructed to mount the IC chip 3 from the UI section 710, this IC chip attaching section 730 controls the stapler 54 (FIG. 4) so that this stapler 54 staples the staple needle 42a (FIG. 1) on the printing paper 40 on which the original image is printed.

When data is input from the UI section 710 to the data writing section 740, this data writing section 740 controls the IC chip 28 (FIGS. 3 and 4) to write this input data into the IC chip 3 attached to the printing paper 40.

[Overall Operation]

Next, overall operation of the copying apparatus 1 will be described.

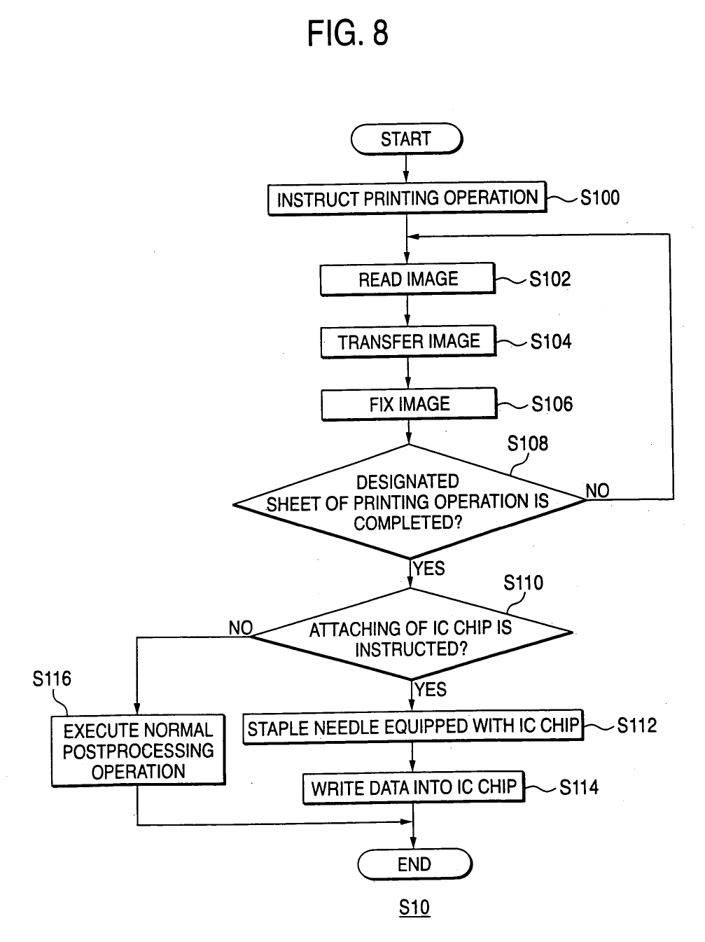

FIG. 8 is a flow chart for describing an operation (S10) of the copying apparatus 1 (printing program 7).

As shown in FIG. 8, in a step 100 (S100), a user performs an operation for instructing a commencement of a printing operation with respect to the UI apparatus 26 (FIGS. 3 and 4).

Upon receipt of this operation, the UI section 710 (FIG. 7) outputs data for instructing the commencement of the printing operation to the image reading section 700 and the like.

In a step 102, when the operation of the commencement of the printing operation is carried out with respect to the UI apparatus 26 (FIGS. 3 and 4), the image reading section 700 controls the scanner 17 (FIG. 4) and the like to read an original image displayed on an original.

In a step 104 (S104), the printing section 720 (FIG. 7) controls the print engine 14 (FIG. 4) so that a toner image of the read original image is formed on a drum (not shown), and then, the formed toner image is transferred onto the printing paper 40.

In a step 106 (S106), the printing section 720 (FIG. 7) controls the fixing roller 15 (FIG. 4) and the pressure roller 16 (FIG. 4) to heat the toner image on the printing paper 40 and to fix the toner image transferred onto the printing paper 40.

The printing paper 40 on which the toner image is fixed is transported to the postprocessing unit 50 (FIG. 4) to be stored in the compile tray 52 (FIG. 4).

In a step 108 (S108), the printing program 7 (FIG. 7) judges as to whether or not a designated sheet of printing operation has been accomplished.

When the printing program 7 judges that the designated sheet of printing operation has been completed, the process is advanced to another process of a step S110, whereas in other cases than the above-explained case, the processes from the step S102 to the step S106 are repeatedly carried out.

For example, when the user merely performs to commence a printing operation with respect to the UI apparatus 26 (FIGS. 3 and 4), the copying apparatus 1 executes a simple copying process operation.

In contrast to this operation, when the user performs to commence the printing operation after the user has instructed the UI apparatus 26 to attach the IC chip 3, the copying apparatus 1 executes the postprocessing operation according to the embodiment of the present invention.

In the step 110 (S110), the UI section 710 (FIG. 7) judges whether the user simply performs the operation for the copying operation, or instructs to attach the IC chip 3.

When the user executes the former operation (copying operation), the printing program 7 is advanced to a process of a step S116, whereas in other cases than the above-described case, the printing program 7 is advanced to another process operation of a step S112.

In the step 112 (S112), the IC chip attaching section 730 (FIG. 7) controls the stapler 54 (FIG. 4) and the like to staple the staple needle 42a on which the IC chip 3 is held to the printing paper 40 stored in the compile tray 54.

It should also be understood that even when total sheet of printing paper 40 stored in the compile tray 54 is one sheet, the IC chip attaching section 730 staples the staple needle 42a on one sheet of this printing paper 40.

In a step 114 (S114), the data writing section 740 (FIG. 7) controls the IC chip IF 28 (FIG. 4) to write data into the IC chip 3 attached to the printing paper 40.

When the data writing operation is accomplished, the postprocessing unit 50 (FIG. 4) transports and discharges the printing paper 40, and the process operation is ended.

In a step 116 (S116), the postprocessing unit 50 executes the normal postprocessing operation, for example, punching or stapling operation with respect to the printing paper 40, and then, the process operation is accomplished.

It should be understood that when attaching of the IC chip 3 is not instructed, the postprocessing unit 50 prohibits the stapling process operation when one sheet of printing paper 40 is stored in the compile tray 54.

As described above, after the process operations executed under high temperature/high voltage environments in the printing operation have been accomplished, the copying apparatus 1 staples the staple needle 42a on which the IC chip 3 is held on the printing paper 40.

[Modifications of Staple Needles]

It should also be noted that if a staple needle holds the IC chip 3 and can be protected in such a manner that this staple needle is not depressed by a stapler 54 (FIG. 1B), this staple may be made of other shapes than the above-described shape of the staple needle 42a.

Modifications of the staple needle 42a will now be explained below.

First, a second staple needle 42b will now be explained.

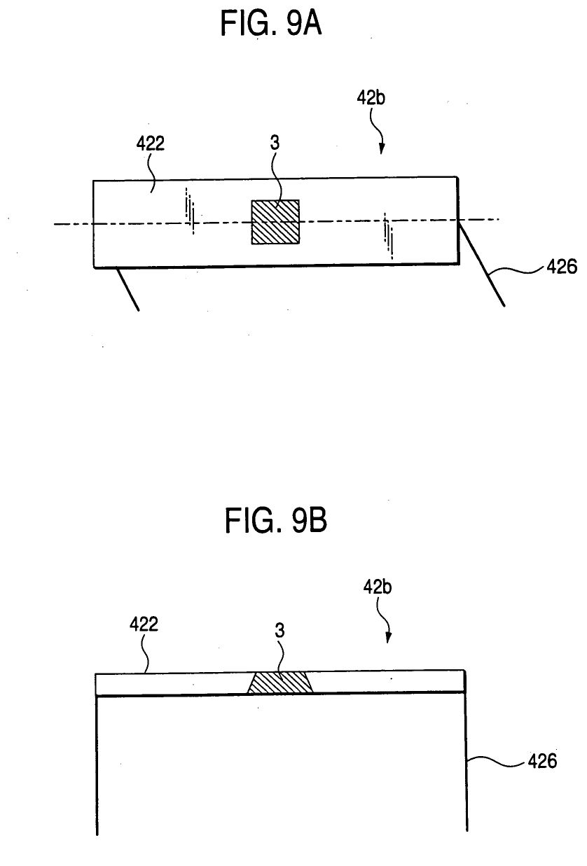

FIG. 9A illustratively shows an outer appearance of this second staple needle 42b, which is viewed from an oblique direction. FIG. 9B is an explanatory diagram for showing a sectional view of the second staple needle 42b shown in FIG. 9A, taken along a two-dot/dash line.

As shown in FIG. 9A, the second staple needle 42b includes a plate-shaped holding portion 422 and needle-shaped leg portions 426.

The holding portion 422 has a plate shape in which a plane depressed by the stapler 54 is larger than an adjacent plane thereto. The holding portion 422 defines an opening portion, which open toward a direction depressed by the stapler 54.

As described above, since the IC chip 3 is stored in the opening portion of the second staple needle 42b, when the stapler 54 (FIG. 1B) staples this second staple needle 42b, the IC chip 3 is protected in the housing of the second staple needle 42b, and thus, is not depressed.

It should also be noted that the leg portions 426 of the second staple needle 42b are essentially same as those of the first staple needle 42a.

As shown in FIG. 9B, the holding portion 422 has a thickness thicker than that of the IC chip 3 to prevent the IC chip 3 from being depressed by the stapler 54.

Also, the opening portion formed in the holding portion 422 is opened more largely as approaching to a plane, which is engaged with the printing paper 40. The IC chip 3 has the substantially same shape as the shape of the opening portion of the holding portion 422.

As a result, the IC chip 3 held in the opening portion does not pass through the opening portion in a rear direction of the plane engaging with the printing paper 40. When the staple needle 42b is stapled to the printing paper 40, the IC chip 3 is held by the printing paper 40 and the holding portion 422 and thus is disconnected.

As described above, the construction in which the opening portion is formed in the second staple needle 42b and the IC chip 3 is stored in this opening portion is employed. This construction is suitable for a case that the IC chip 3 is adversely influenced by pressure.

Next, a third staple needle 42c will now be explained.

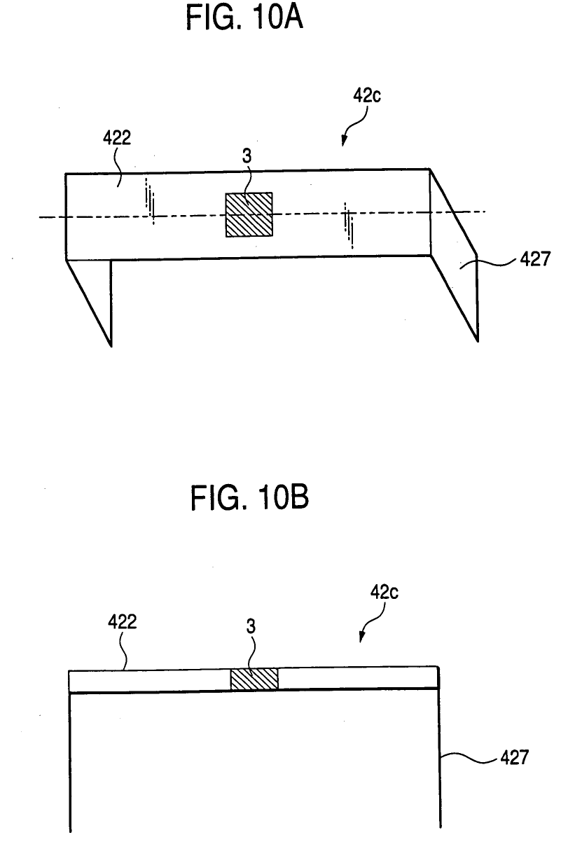

FIG. 10A illustratively shows an outer appearance of this third staple needle 42c viewed from an oblique direction. FIG. 10B is an explanatory diagram for showing a sectional view of the third staple needle 42c shown in FIG. 10A, taken along a two-dot/dash line.

As shown in FIG. 10A, the third staple needle 42c includes a plate-shaped holding portion 422 and plate-shaped leg portions 427.

The leg portions 427 are provided in such a manner that these leg portions 427 are located on both ends of the holding portion 422 at a substantially right angle with respect to this holding portion 422.

It should be noted that the plate-shaped holding portion 422 of this third staple needle 42c is essentially same as that of the second staple needle 42b except for a shape of an opening thereof.

As shown in FIG. 10B, the opening portion of this third staple needle 42c corresponds to an opening portion having the substantially same sizes from a plane of this opening portion engaging with the printing paper 40 to a rear plane thereof.

The leg portions 427 are made in a thin-plate shape in such a manner that these leg portions 427 can pass through the printing paper 40.

Also, the leg portions 427 are made thin in such a degree that when the leg portions 427 abut against the needle receiving base 58 and then, is bent.

Since this third staple needle 42c maybe constituted in such a manner that even after this third staple needle 42c has been stapled on the printing paper 40, the IC chip 3 can be detachably mounted on this third staple needle 42c. This third staple 42c is suitable for such a case that this IC chip 3 is desired to be replaced with other IC chips several times.

Next, a fourth staple needle 42d will now be explained.

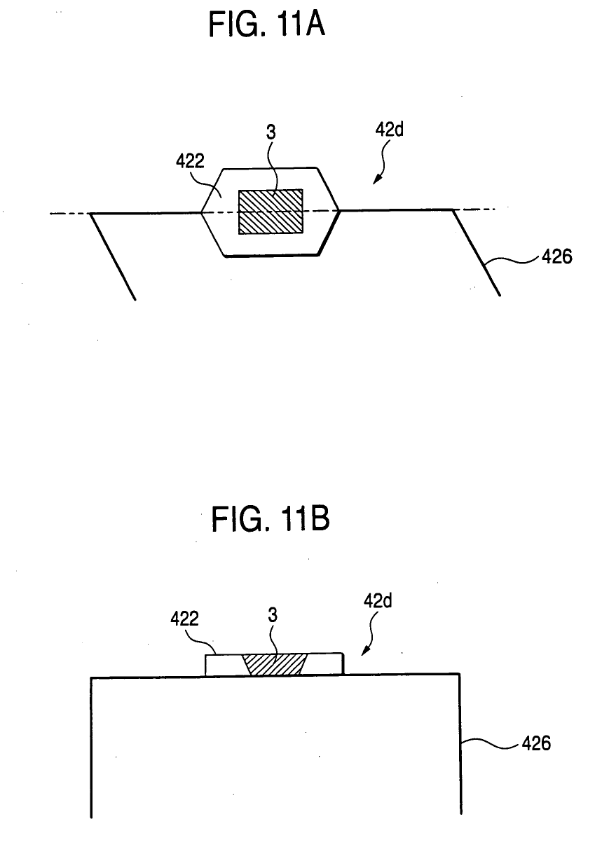

FIG. 11A illustratively shows an outer appearance of the fourth staple needle 42d viewed from an oblique direction.

FIG. 11B is an explanatory diagram for showing a sectional view of the fourth staple needle 42d shown in FIG. 11A, taken along a two-dot/dash line.

As shown in FIG. 11A, the fourth staple needle 42d includes a plate-shaped holding portion 422 and folded needle-shaped leg portions 428.

The holding portion 422 has a thinner hexagonal-cylinder shape. The leg portions 428 are connected to side surfaces of this hexagonal cylinder.

The leg portions 428 each has a needle shape, which is bent at a substantially right angle. The respective two leg portions 428 are elongated in opposite directions to each other from the side surface of the holding portion 422, and also are folded in the same direction.

As represented in FIG. 11B, the fourth staple needle 42d has an opening portion a dimension of which is gradually increased as approaching from a plane thereof engaging with the printing paper 40 to a rear plane thereof.

Since this fourth staple needle 42d holds the IC chip 3 in the opening portion, even after this fourth staple needle 42d has been stapled on the printing paper 40, the IC chip 3 maybe more easily and detachably mounted in this opening portion.

Also, since the holding portion 422 of this fourth staple needle 42d is made smaller, when this fourth staple needle 42d is stapled in the printing paper 40, the fourth staple needle 42d can be hardly and visibly recognized.

Next, a description will be given on a fifth staple needle 42e.

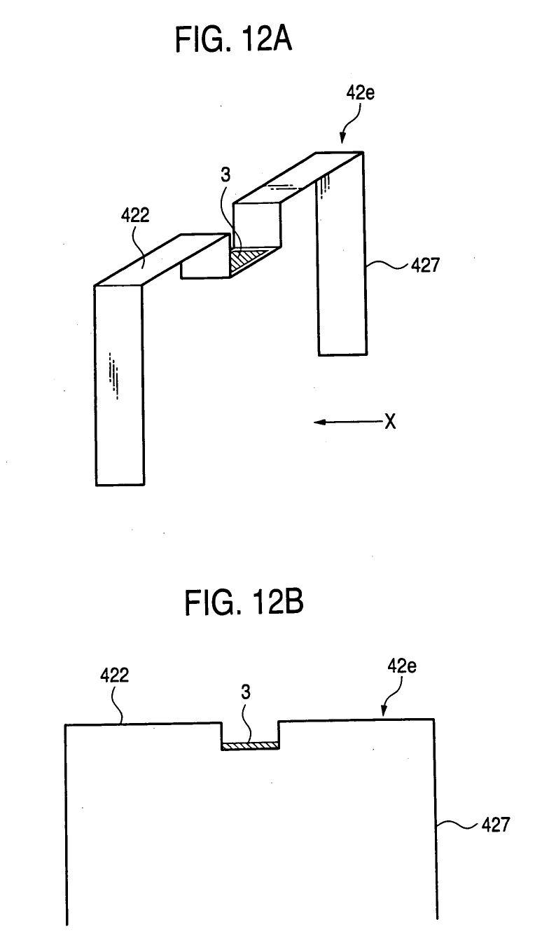

FIG. 12A illustratively shows an outer appearance of the fifth staple needle 42e viewed from an oblique direction. FIG. 12B is a diagram for showing the fifth staple needle 42e shown in FIG. 12A, as viewed from an arrow “X” direction.

As shown in FIG. 12A, this fifth staple needle 42e includes a plate-shaped holding portion 422 and plate-shaped leg portions 427.

The holding portion 422 is folded in such a manner that a concave portion is formed in a depression plane (upper plane in this drawing). An IC chip 3 is held in this concave portion.

The plate-shaped leg portions 427 are made substantially same as those shown in FIG. 10.

As shown in FIG. 12B, in this modified example of the fifth staple needle 42e, the IC chip 3 is fixed on an upper plane of this concave portion of the holding portion 422 by way of an adhesive manner.

As a consequence, even after this fifth staple needle 42e has been stapled on the printing paper 40, the IC chip 3 may be attached to this fifth staple needle 42d.

Also, since this fifth staple needle 42e can be manufactured by bending one sheet of a plate-shaped member, higher productivity thereof may be realized.

Next, a description will be given on a sixth staple needle 42f.

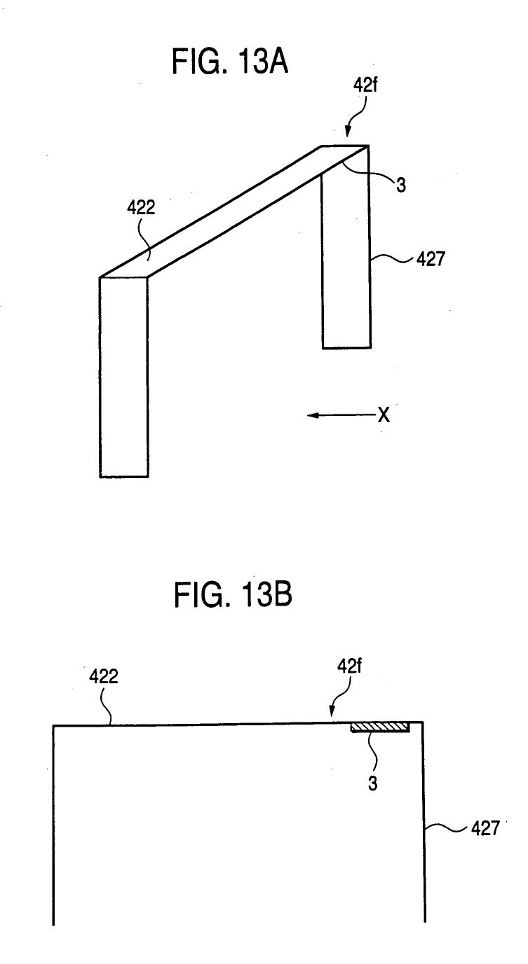

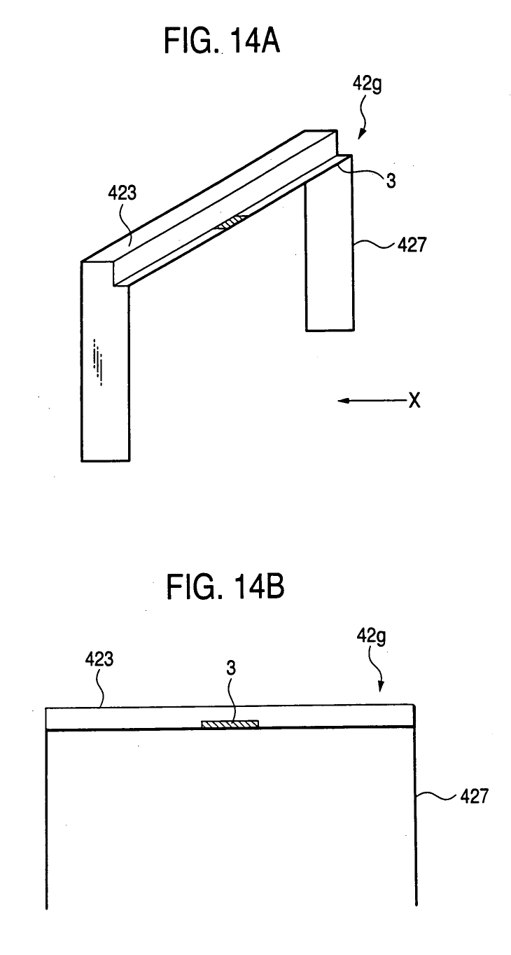

FIG. 13A illustratively shows an outer appearance of the sixth staple needle 42f viewed from an oblique direction. FIG. 13B is a diagram for showing the sixth staple needle 42f shown in FIG. 13A, as viewed from an arrow “X” direction.

As shown in FIG. 13A, this sixth staple needle 42f includes a plate-shaped holding portion 422 and plate-shaped leg portions 427.

The holding portion 422 and the leg portions 427 are plate-shaped members, and are located substantially perpendicular to each other.

As shown in FIG. 13B, this sixth staple needle 42f holds an IC chip 3 on a rear plane of a depression plane of the holding portion 422. The IC chip 3 of this modified example is held in the vicinity of an edge portion of the rear plane (lower portion in this drawing) of the holding portion 422, that is, this IC chip 3 is held in the vicinity of one of these two leg portions 427.

As a result, when the IC chip 3 is attached to the sixth staple needle 42f and then this sixth staple needle 42f is stapled on the printing paper 40, this IC chip 3 may disappear.

Also, since this sixth staple needle 42f may be manufactured by folding one sheet of a plate-shaped member, higher productivity thereof can be achieved.

Next, a description will be given on a seventh staple needle 42g.

FIG. 14A illustratively shows an outer appearance of the seventh staple needle 42g viewed from an oblique direction. FIG. 14B is a diagram for showing the seventh staple needle 42g shown in FIG. 14A, as viewed from an arrow “X” direction.

As shown in FIG. 14A, this seventh staple needle 42g includes a holding portion 423, the depression plane of which is folded in a step manner, and plate-shaped leg portions 427.

The holding portion 423 has a shape, which is folded in the step manner and is located above a depression plane (upper plane shown in the drawing). Since this shape folded in the step manner is folded along a short axial direction of the holding portion 423, this folded-shaped holding portion 423 can be hardly bent in a long axial direction. The leg portions 427 are substantially identical to those shown in FIG. 10.

As shown in FIG. 14B, since the seventh staple needle 42g of this modified example may be constructed in such a manner that this staple needle 42g can be hardly bent in the long axial direction of the holding portion 423, it is possible to avoid that the IC chip 3 is destroyed due to bending of the holding portion 423.

It should also be noted that the first staple needle 42a (FIG. 1) may be formed by cutting a long wire-shaped material every stapling operation. Similarly, the third staple needle 42c (FIG. 10), the fifth staple needle 42e (FIG. 12), and the sixth staple needle 42f (FIG. 13) may be formed by cutting a long plate-shaped material every stapling operation.

In theses cases, while either a wire-shaped material or a plate-shaped material is employed into which IC chips 3 have been previously embedded in a predetermined interval, the copying apparatus 1 may form the staple needle 42. Also, after the staple needle 42 has been stapled on the printing paper 40, the copying apparatus 1 may attach the IC chip 3 to this staple needle 42.

[Adhesive Tape]

The embodiments in which the IC chips 3 are held in the staple needles have been described. The IC chip 3 may be held on an adhesive tape and this adhesive tape may be attached to the printing paper 40.

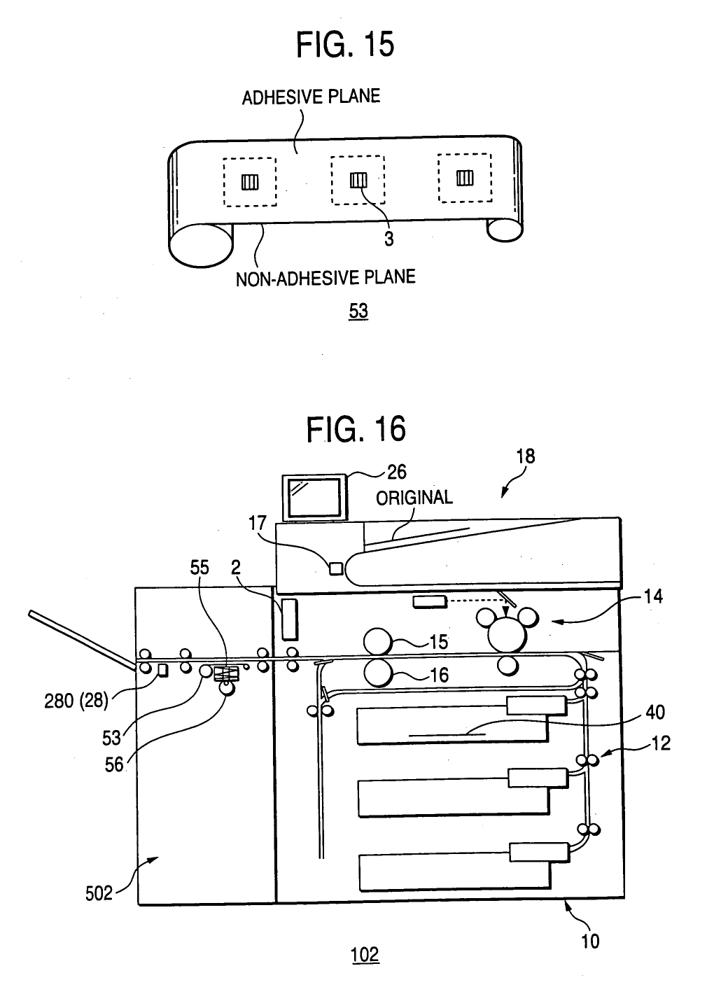

FIG. 15 is a diagram for showing an example of an adhesive tape 53, which holds thereon an IC chip 3.

As shown in FIG. 15, the adhesive tape 53 (adhesive member) includes an adhesive plane having an adhesive characteristic, and a non-adhesive plane having no adhesive characteristic. The IC chip 3 is held on this adhesive plane of the adhesive tape 53.

The adhesive tape 53 is cut out at positions indicated by broken lines, and then, the cut adhesive tapes 53 are attached to the printing paper 40.

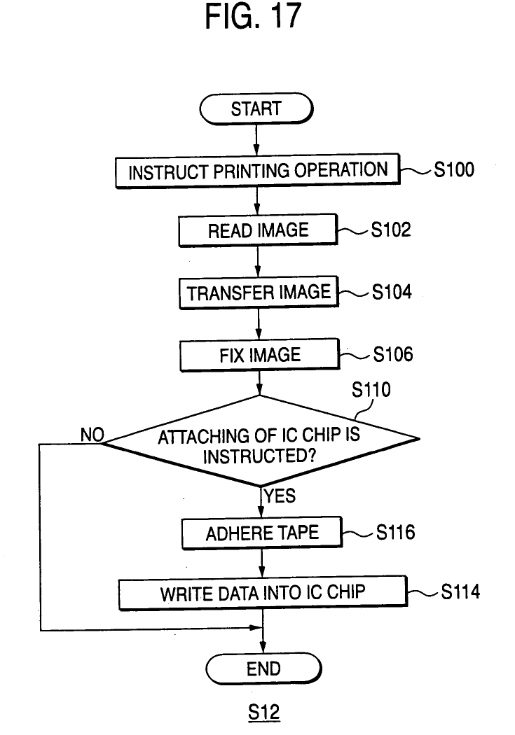

FIG. 16 is a diagram for showing a second copying apparatus 102, which mounts the IC chip 3 by utilizing the adhesive tape 53 (FIG. 15).

As shown in FIG. 16, this second copying apparatus 102 includes a second postprocessing unit 502.

It should be noted that constituent components of the second copying apparatus 102, which are substantially same as those of the first copying apparatus 1, are allotted the same reference numerals.

The postprocessing unit 502 includes the adhesive tape 53 on which the IC chip 3 is held, a punch 55, and a cam 56, and the like. The punch 55 attaches the adhesive tape 53 to the printing paper 40. The cam 56 rotates an eccentric shaft (not shown in detail) to move the punch 55 in upper/lower directions.

The punch 55 is always depressed in the lower direction by receiving force exerted from a spring (not shown).

When the cam 56 is rotated to push up the punch 55, the punch 55 may push up the adhesive tape 53, which is bridged in an upper direction, and then punches a portion of the adhesive tape 53 where the IC chip 3 is held, and thereafter adheres the punched adhesive tape to a rear surface of a plane of the printing paper 40 on which an image is formed.

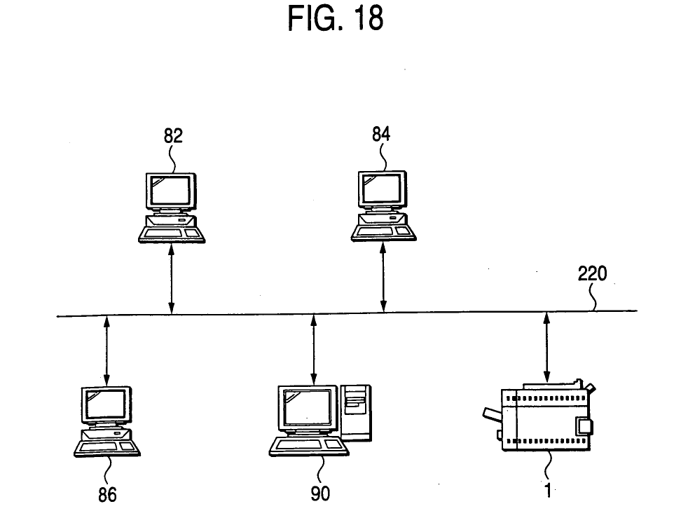

FIG. 17 is a flow chart for describing an operation (step S12) of the second copying apparatus 102 (printing program 7) with employment of the adhesive tape 53.

It should also be noted that steps of FIG. 17, which are substantially same as those of FIG. 8, are allotted the same reference numerals.

In the processing of this second copying apparatus 102, when it is so judged that an instruction of attaching the IC chip 3 is issued in a process of a step S110, the IC chip attaching section 730 (FIG. 7) controls the punch 55 (FIG. 16) and the like to adhere the adhesive tape 53 on which the IC chip 3 is held to the printing paper 40 in a process of a step 116 (S116).

As described above, the second copying apparatus 102 can attach the IC chip 3 to the printing paper 40 by employing the adhesive tape 53.

[Network Printer]

The copying apparatus 1 accepts the operation of the user via the UI apparatus 26 (FIGS. 3 and 4) of this copying apparatus 1, so that this copying apparatus 1 attaches the IC chip 3 and also writes the data into this IC chip 3. Alternatively, the copying apparatus 1 may receive an instruction via a network from a computer terminal connected to this copying apparatus 1, so that this copying apparatus 1 may attach the IC chip 3 and write data into this IC chip 3.

FIG. 18 is a diagram for showing a network structure of the copying apparatus 1, which is commonly used by a plurality of computer terminals.

The copying apparatus 1 is connected via a network 220 such as a LAN (Local Area Network) to a computer terminal 82, another computer terminal 84, still another computer terminal 86, and a server terminal 90.

The copying apparatus 1 is a composite machine equipped with a copy function and a printer function. The copy apparatus 1 prints image data received from the computer terminal 82.

Also, in response to an input operation for the computer terminals 82, the copying apparatus 1 controls the postprocessing unit 50 (FIG. 4) to attach the IC chip 3.

Furthermore, the copying apparatus 1 receives data, which is input from the computer terminal 82 and the like, via the network 220 and then, writes the received data into the IC chip 3.

As described above, since this copying apparatus 1 attaches the IC chip 3 and writes data into this attached IC chip 3 in response to the instruction issued from the computer terminal 82 and the like, the user can perform various operations by instructing with respect to the computer terminals only one time. These various operations may cover a transmission of print data, a printing instruction, attaching of the IC chip 3, a transmission of data to be written into the IC chip 3, and a data writing instruction to the IC chip 3.

Alternatively, in response to data (e.g., data ID) read out from the IC chip 3, the copying apparatus 1 may acquire image data from the server terminal 90 to print the acquired image data.

Concretely speaking, the computer terminal 82 (FIG. 18) transmits the image data to the copying apparatus 1, and also, instructs this copying apparatus 1 to attach the IC chip 3.

The copying apparatus 1 prints the image data received from the computer terminal 82 on the printing paper 40, and then, attaches the IC chip 3 to this printing paper 40. Furthermore, the copying apparatus 1 records the received image on the server terminal 90, and writes recording position information (for example, data ID capable of discriminating image data) of the image data into this IC chip 3.

Subsequently, when the copying apparatus 1 copies this printing paper 40, the copying apparatus 1 reads the data ID from the IC chip 3 attached to this printing paper 40, and then acquires the image data corresponding to this read data ID from the server terminal 90 to print this acquired image data on the printing paper 40.

As described above, since the image data is recorded in the server terminal 90, it is possible to prevent deteriorations of image qualities, which are caused by repeatedly performing the copying operation, and also possible to suppress a size of data which is written into the IC chip 3.

It should also be noted that as the recording positional information of the image data, identification information (URL, IP address etc.) of the server terminal 90 may be written into the IC chip 3 in addition to the data ID.

As described above in detail, in accordance with the postprocessing apparatus and the postprocessing method according to the embodiment of the present invention, the semiconductor chip can be mounted on the image forming member where the image is to be formed.

What is claimed is:

1. A postprocessing apparatus for performing a postprocessing with respect to an image forming member on which an image is to be formed, the postprocessing apparatus comprising:
an attachment unit for attaching a storage medium to the image forming member on which it has started to form the image.

2. The postprocessing apparatus according to claim 1, wherein:
the attachment unit attaches the storage medium to the image forming member after a process of transferring the image onto the image forming medium.

3. The postprocessing apparatus according to claim 1, wherein:
the attachment unit attaches the storage medium to the image forming member after a process of fixing the image onto the image forming member.

4. The postprocessing apparatus according to claim 1, further comprising:
a data writing unit for writing data into the storage medium.

5. The postprocessing apparatus according to claim 4, wherein the data writing unit writes data input by user into the storage medium.

6. The postprocessing apparatus according to claim 4, wherein:
the data writing unit writes the data into the storage medium attached to the image forming member.

7. The postprocessing apparatus according to claim 1, wherein the attachment unit attaches the storage medium on the basis of an operation of user.

8. The postprocessing apparatus according to claim 1, further comprising:
a communication interface connected to an external terminal through a network and receiving an operation of instructing the attachment of the storage medium from the external terminal, wherein:
the attachment unit attaches the data storage unit in response to the received operation.

9. The postprocessing apparatus according to claim 1, wherein:
a staple needle holds the storage medium; and
the attachment unit staples the staple needle holding the storage medium to the image forming member to attach the storage medium to the image forming member.

10. The postprocessing apparatus according to claim 9, wherein:
the attachment unit staples the staple needle to the single image forming member.

11. The postprocessing apparatus according to claim 1, wherein:
an adhesive member holds the storage medium; and
the attachment unit attaches the adhesive member holding the storage medium to the image forming member.

12. A staple needle to be attached to a sheet-shape member, the staple needle comprising:
a holding portion for holding a storage medium, which stores data.

13. A staple needle to be attached to a sheet-shape member, the staple needle comprising:
a data storage unit for storing data.

14. The staple needle according to claim 12, wherein:
at least a part of the staple needle serves as an antenna for transmitting/receiving the stored data.

15. A method for performing a postprocessing with respect to an image forming member on which an image is to be formed, the method comprising:
attaching a storage medium to the image forming member on which it has started to form the image.
